(19) United States
(12) Patent Application Publication
(10) Pub. No.: US 2021/0078084 A1
(43) Pub. Date: Mar. 18, 2021

(54) CUTTING SECTION FOR A CORE BIT

(71) Applicant: Hilti Aktiengesellschaft, Schaan (LI)

(72) Inventors: Florian SCHROEDER, Maienfeld (CH); Guenter DOMANI, Weissenberg (DE); Pingyan RONG, Feldkirch (AT)

(21) Appl. No.: 16/954,041

(22) PCT Filed: Dec. 17, 2018
(86) PCT No.: PCT/EP2018/085138

§ 371 Date: Jun. 16, 2020

(30) Foreign Application Priority Data
Dec. 21, 2017 (EP) 17209601.8

(51) Int. Cl. B23B 51/04

(52) U.S. Cl. CPC B23B 51/0466; B23B 2265/32; B23B 2251/50

(57) ABSTRACT

A cutting section (11) which is connectable to a drill shaft section via a releasable connecting device. The cutting section includes a first closed tubular element (14) which is in the form of a first hollow cylinder having a first waved, trapezoidal or zigzag-shaped cross-sectional area, a second closed tubular element (15) which is in the form of a second hollow cylinder having a circular ring-shaped cross-sectional area, and one or more drill segments (16) which are connected to the first closed tubular element (14).

### TECHNICAL FIELD

The present invention relates to a cutting section for a core wherein the cutting section is connectable to the core bit via a releasable connection.

BACKGROUND

The design described in WO 2014/096359 A1 has become established as the design for cutting sections which are connectable to a drill shaft section via a releasable connecting device. The cutting section comprises one or more drill segments, a ring section, an outer push element and an annular stop shoulder at the transition from the ring section to the outer push element; the releasable connecting device is in the form of a combined push and twist connection. The cutting section comprises slot-shaped recesses of T shape which are arranged in the outer push element.

During the drilling of substrates composed of reinforced concrete, the problem of jammed core bits occurs. A cause of the jamming of the core bit can be an iron wedge which is severed on the inner side of the cutting section and wedges in the inner gap between the drill core and the cutting section. It is known from 2017/108461 A1 that, in the case of core bits having a small internal projection of the drill segments in relation to the drill shaft, the risk of the cutting section of a core bit becoming jammed in the substrate is reduced. However, a small internal projection of the drill segments leads to a narrow inner gap on the inner side of the core bit and therefore to disadvantages during the wet drilling with the core bit. During the wet drilling, a cooling and flushing liquid is required which, as cooling liquid, cools the drill segments and, as flushing liquid, transports drilling debris out of the drill hole. The clean cooling and flushing liquid is supplied via the inner gap between the drill core and the core bit. Cooling and flushing liquid cannot be sufficiently transported to the machining site via the narrow inner gap.

As measures for improving the supply of the cooling and flushing liquid in the case of core bits having a small internal projection of the drill segments, WO 2017/108461 A1 describes the use of transport channels on the inner side of the drill shaft or the use of drill shafts having a waved, trapezoidal or zigzag-shaped cross-sectional area.

In the case of core bits having a releasable cutting section, transport channels can improve the supply of liquid. It is disadvantageous to replace the cutting section which is known from WO 2014/096359 A1 and has a circular ring-shaped cross-sectional area by a cutting section having a waved, trapezoidal or zigzag-shaped cross-sectional area.

### SUMMARY OF THE INVENTION

An object of the present invention is to further develop a cutting section for a core bit to the effect that the risk of the cutting section becoming wedged in the substrate during drilling in reinforced concrete is reduced. In addition, the manufacturing outlay for the production of a cutting section is intended to be reduced.

The cutting section is provided for a core bit and is designed to be connectable to a drill shaft section of the core bit via a releasable connecting device. The cutting section is characterized by:
a first closed tubular element which is in the form of a first hollow cylinder having a first waved, trapezoidal or zigzag-shaped cross-sectional area and which has a first hollow cylinder height, a first inside diameter and a first outside diameter,
a second closed tubular element which is in the form of a second hollow cylinder having a second circular ring-shaped cross-sectional area and which has a second hollow cylinder height, a second inside diameter and a second outside diameter, wherein the second inside diameter is larger than the first inside diameter, and the first outside diameter is larger than or equal to the second outside diameter, and
one or more drill segments which are connected to the first closed tubular element,
wherein the first upper end surface of the first closed tubular element is connected to the second lower end surface of the second closed tubular element.

By separation of the cutting section into the first closed tubular element and the second closed tubular element, an adaptation of the cutting section to the different demands made with regard to transmission of force, transmission of torque and stability in relation to tensile loadings during the removal of a jammed core bit can be taken into consideration. In addition, hollow cylinders having a different cross-sectional area can be used.

The cutting section according to the invention comprises a first closed tubular element, a second closed tubular element and at least one drill segment. The first closed tubular element is in the form of a first hollow cylinder having a first waved, trapezoidal or zigzag-shaped cross-sectional area and comprises a first outer lateral surface, a first inner lateral surface, a first lower end surface and a first upper end surface. The second closed tubular element is in the form of a second hollow cylinder having a second circular ring-shaped cross-sectional area and comprises a second outer lateral surface, a second inner lateral surface, a second lower end surface and a second upper end surface. The first closed tubular element and the second closed tubular element are connected via the first upper end surface of the first closed tubular element and the second lower end surface of the second closed tubular element; the first upper end surface and second lower end surface can be connected, for example, by welding.

The cutting section is designed in such a manner that force is transmitted from a drill shaft section via the first closed tubular element and torque is transmitted from the drill shaft section via the second closed tubular element. Since the first inside diameter of the first closed tubular element is smaller than the second inside diameter of the second closed tubular element, the first upper end surface on the inner side of the cutting section forms an annular stop shoulder which is used for transmitting force. A drill shaft section transmits the force to the annular stop shoulder by means of an annular end surface. Torque is transmitted, for example, via pin elements of the drill shaft section which interact with slot-shaped recesses in the second closed tubular element. By separation of the cutting section into the first closed tubular element and the second closed tubular element, the different demands made of the cutting section in respect of transmission of force and transmission of torque can be taken into consideration.

The first closed tubular element which is in the form of a first hollow cylinder having a first waved, trapezoidal or zigzag-shaped cross-sectional area permits the design of a cutting section without an internal projection or with a small internal projection of the drill segments on the inner side of the cutting section since the cooling and flushing liquid can be transported in the required quantity to the machining site via the depressions. In addition, the manufacturing outlay for the production of the cutting section is reduced. The first upper end surface forms the annular stop shoulder for transmitting force, thus obviating the need for turning. The first closed tubular element can be produced from a first profiled metal sheet which is formed into a first open tubular element and is connected at first abutting edges in an integrally bonded or form fitting manner. The second closed tubular element can be produced from a second flat sheet metal part which is formed into a second open tubular element and is connected at second abutting edges in an integrally bonded or form fitting manner.

Preferably, the first outside diameter is substantially identical to the second outside diameter, and the first outer lateral surface of the first closed tubular element and the second outer lateral surface of the second closed tubular element are aligned flush. The cutting section is designed in such a manner that force is transmitted via the first upper end surface on the inner side of the cutting section. The first upper end surface forms an annular stop shoulder for transmitting force. Force is transmitted between the annular stop shoulder of the cutting section and an annular end surface of a drill shaft section. By means of the flush alignment of the first outer lateral surface and the second outer lateral surface, the available width is used in the best possible way for the annular stop shoulder. The first outside diameter and the second outside diameter correspond in the context of manufacturing accuracies.

The second closed tubular element preferably has at least one slot-shaped recess, wherein the at least one slot-shaped recess has a transverse slot and a connecting slot, and the connecting slot connects the transverse slot to the second upper end surface of the second closed tubular element. The at least one slot-shaped recess is part of the releasable connecting device which connects the cutting section to a drill shaft section of the core bit. The slot-shaped recess is T-shaped or L-shaped and, in the connected state of the core bit, permits a relative movement between the cutting section and the drill shaft section. The relative movement between the cutting section and the drill shaft section enables a jammed cutting section to be released from the substrate.

The second closed tubular element in the second inner lateral surface particularly preferably has at least one transverse groove which is arranged level with the connecting slot of the slot-shaped recess. The at least one transverse groove is part of the releasable connecting device which connects the cutting section to a drill shaft section of the core bit. The width of the transverse groove is greater than or equal to the width of the transverse slot of the slot-shaped recess. A matching transverse lug of a drill shaft section engages in the transverse groove of the cutting section. The transverse groove and transverse lug form an additional form fitting connection which prevents the push and twist connection from being unintentionally opened during release of a jammed core bit and the drill shaft section from being removed from the substrate without the cutting section.

In a preferred development, the first closed tubular element is formed from a first material and the second closed tubular element from a second material. The cutting section according to the invention is designed in such a manner that force is transmitted to the cutting section via the first closed tubular element and torque is transmitted to the cutting section via the second closed tubular element. By separation of the cutting section into the first closed tubular element and the second closed tubular element, the choice of the first material for the first closed tubular element and of the second material for the second closed tubular element can be adapted to the different demands made of the cutting section in respect of transmission of force and transmission of torque. In addition, the second material can be adapted in respect of tensile loadings during the removal of a jammed core bit.

The first closed tubular element is preferably in the form of a first formed sheet metal part. The use of a first formed sheet metal part permits the production of the first closed tubular element from profiled metal sheets. The first closed tubular element can be produced from a first profiled metal sheet which is formed into a first open tubular element and is connected at the first abutting edges. Cold forming methods and hot forming methods are suitable as the forming method for the first sheet metal part. The first abutting edges can be connected in an integrally bonded or form fitting manner, with the abutting edges of tubular elements conventionally being connected in an integrally bonded manner by welding. In addition to the integrally bonded connection, the first abutting edges can be connected in a form fitting manner.

The second closed tubular element is preferably in the form of a second formed sheet metal part. The use of a second formed sheet metal part permits the production of the second closed tubular element from flat sheet metal parts. The second closed tubular element can be produced from a second sheet metal part which is formed into a second open tubular element and is connected at the second abutting edges. The at least one slot-shaped recess can be produced in the second sheet metal part, for example, by punching or cutting out. Cold forming methods and hot forming methods are suitable as the forming method for the second sheet metal part. The second abutting edges can be connected in an integrally bonded or form fitting manner, with the abutting edges of tubular elements conventionally being connected in an integrally bonded manner by welding. In addition to the integrally bonded connection, the second abutting edges can be connected in a form fitting manner.

The second formed sheet metal part particularly preferably has at least one second positive form fitting element and at least one corresponding second negative form fitting element on opposite sides, wherein the at least one second positive form fitting element and the at least one second negative form fitting element are connected in a form fitting manner in the second closed tubular element. The connection of the second abutting edges via second form fitting elements has the advantage that heat which may lead to stresses in the second closed tubular element is not admitted into the second open tubular element.

The cutting section according to the invention for a core bit is provided for connection to a drill shaft section of the core bit. The invention furthermore relates to a core bit with a cutting section and a drill shaft section, wherein the cutting section and the drill shaft section are connectable via a releasable connecting device.

### BRIEF DESCRIPTION OF THE DRAWINGS

Exemplary embodiments of the invention are described hereinafter with reference to the drawing. It is not necessarily intended for this to illustrate the exemplary embodiments to scale; instead, the drawing, where conducive to elucidation, is produced in schematic and/or slightly distorted form. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be limited compared to the subject matter claimed in the claims. For given design ranges, values within the limits mentioned will also be disclosed as limit values and will be usable and claimable as desired. For the sake of simplicity, identical reference signs are used hereinafter for identical or similar parts or parts having identical or similar function.

In the drawing:

FIGS. 1A and 1B show a core bit with a cutting section according to the invention and a drill shaft section, which are connectable via a releasable connecting device, in an unconnected state of the core bit (FIG. 1A) and in a connected state of the core bit (FIG. 1B); and

FIGS. 2A, 2B and 2C show the cutting section according to the invention of FIGS. 1A and 1B consisting of a first closed tubular element, a second closed tubular element and a plurality of drill segments (FIG. 2A showing all and FIG. 2B showing the first closed tubular element and FIG. 2C the second closed tubular element) in a longitudinal section along the section line A-A in FIG. 1A.

### DETAILED DESCRIPTION

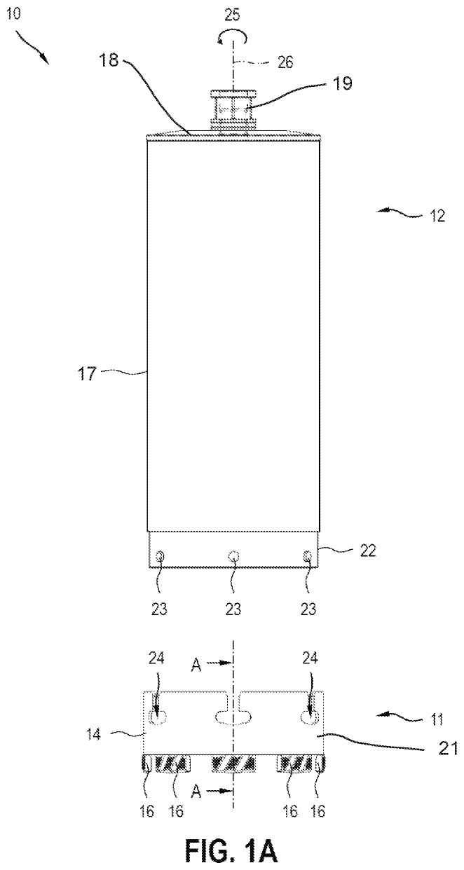

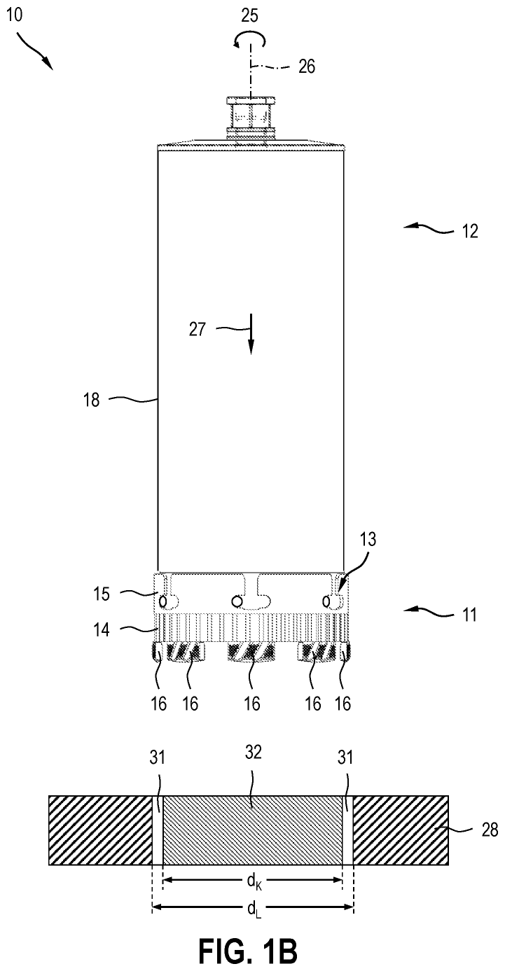

FIGS. 1A and 1B show a core bit 10 which comprises a cutting section 11 according to the invention and a drill shaft section 12, wherein the cutting section 11 and the drill shaft section 12 are connectable via a releasable connecting device 13. In this case, FIG. 1A shows the cutting section 11 and drill shaft section 12 in an unconnected state of the core bit, and FIG. 1B shows the cutting section 11 and drill shaft section 12 in a connected state of the core bit.

The cutting section 11 comprises a first closed tubular element 14, a second closed tubular element 15 and a plurality of drill segments 16 which are connected to the first closed tubular element 14. The drill segments 16 are arranged annularly and form a drill ring with intermediate spaces. Instead of a plurality of drill segments 16, the cutting section 11 can also have an individual drill segment in the form of a closed drill ring. The drill segments 16 are welded, soldered or screwed to the first closed tubular element 14 or fastened to the first closed tubular element 14 using another suitable type of fastening.

The drill shaft section 12 comprises a tubular drill shaft 17, a cover 18 and a shank 19 via which the core bit 10 is fastened in a tool fitting of a core drill.

The releasable connecting device 13 is in the form of a combined push and twist connection, as disclosed in WO 2014/096359 A1. The releasable connecting device 13 comprises a first push element 21 which is integrated in the cutting section 11, and a second push element 22 which is integrated in the drill shaft section 12. The first and second push elements 21, 22 form a push connection and are additionally secured via a twist connection. The twist connection comprises a plurality of pin elements 23 which are introduced into slot-shaped recesses 24. The pin elements 23 are fastened to an outer side of the second push element 22, and the slot-shaped recesses 24 are provided in the first push element 21. The cutting section 11 can be connected simply and rapidly to the drill shaft section 12 by the operator. For this purpose, the cutting section 11 with the first push element 21 is pushed onto the second push element 22 of the drill shaft section 12 in such a manner that the pin elements 23 are arranged in the slot-shaped recesses 24.

In the drilling mode, the core bit 10 is driven by a core drill in one direction of rotation 25 about an axis of rotation 26, wherein the axis of rotation 26 coincides with a longitudinal axis of the tubular drill shaft 17. During the rotation of the core bit 10 about the axis of rotation 26, the core bit 10 is moved in a feed direction 27 into a workpiece 28, with the feed direction 27 running parallel to the axis of rotation 26. In the workpiece 28, the core bit 10 produces a drill hole 31 with a drill hole diameter d_{L} and a drill core 32 with a core diameter d_{K}. The drill segments 15 form a drill ring with an outside diameter which corresponds to the drill hole diameter d_{L} and with an inside diameter which corresponds to the core diameter d_{K}.

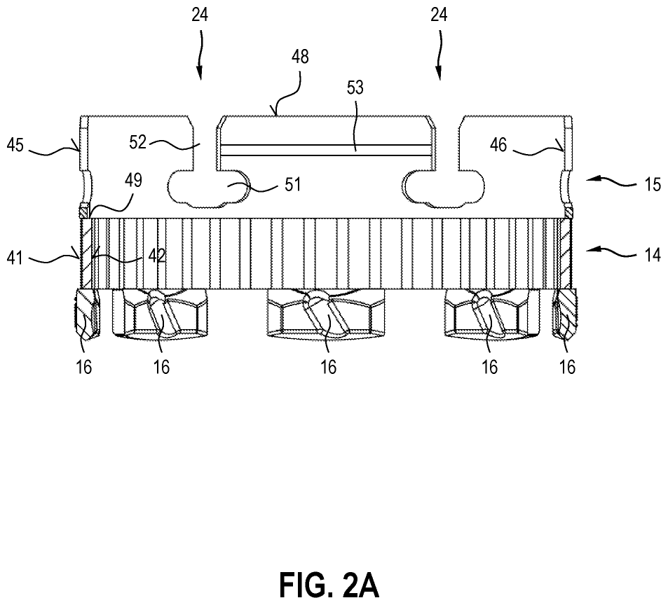

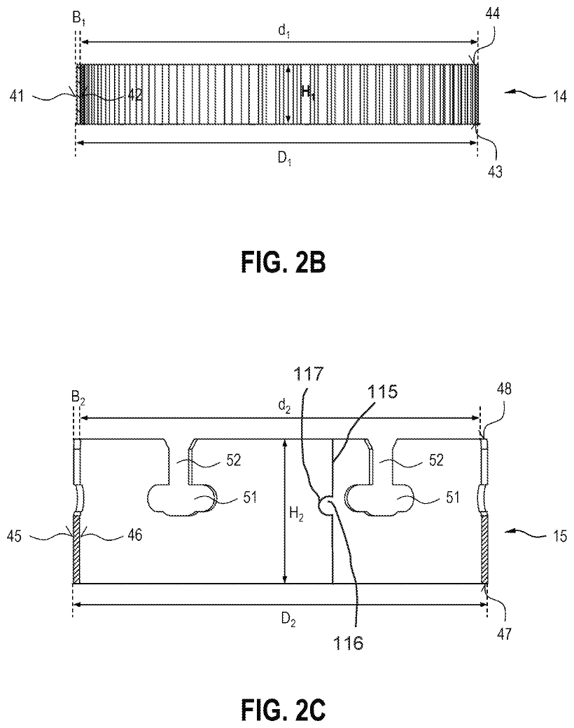

FIGS. 2A, 2B and 2C show the cutting section 11 according to the invention of FIG. 1 with the first closed tubular element 14, the second closed tubular element 15 and the drill segments 16 in a longitudinal section along the section line A-A in FIG. 1A. FIG. 2B shows the first closed tubular element 14 and FIG. 2C shows the second closed tubular element 15 of the cutting section 11.

The cutting section 11 is produced from the first closed tubular element 14, the second closed tubular element 15 and the drill segments 16. The first closed tubular element 14 is connected to the second closed tubular element 15 and to the drill segments 16. The drill segments 16 here can be welded, soldered or screwed to the first closed tubular element 14 or fastened to the first closed tubular element 14 using another suitable type of fastening.

As shown in FIG. 2B, the first closed tubular element 14 is in the form of a first hollow cylinder having a waved cross-sectional area. The first closed tubular element 14 comprises a first outer lateral surface 41, a first inner lateral surface 42, a first lower end surface 43 and a first upper end surface 44. The dimensions of the first closed tubular element 14 are defined by a first hollow cylinder height H₁, a first inside diameter d₁ and a first outside diameter D₁. The width of the first closed tubular element 14 is produced as half the difference of the first outside diameter D₁ and the first inside diameter d₁ and is referred to as the first width B₁. The diameter of an inner circle is defined as the first inside diameter d₁ and the diameter of an outer circle is defined as the first outside diameter D₁.

As shown in FIG. 2C, the second closed tubular element 15 is in the form of a second hollow cylinder having a circular ring-shaped cross-sectional area. The second closed tubular element 15 comprises a second outer lateral surface 45, a second inner lateral surface 46, a second lower end surface 47 and a second upper end surface 48. The dimensions of the second closed tubular element 15 are defined by a second hollow cylinder height H₂, a second inside diameter d₂ and a second outside diameter D₂. The width of the second closed tubular element 15 is produced as half the difference of the second outside diameter D₂ and the second inside diameter d₂ and is referred to as the second width B₂. As shown schematically, the second closed tubular element 15 can be connected at second abutting edges 115 in an interlocking manner with a second positive interlocking element 116 and a second negative interlocking element 117.

The first outside diameter D₁ of the first closed tubular element 14 and the second outside diameter D₂ of the second closed tubular element 15 substantially correspond. The limitation “substantially” means here that the first outside diameter D₁ and the second outside diameter D₂ correspond in the context of manufacturing accuracies. In the connected state, the first outer lateral surface 41 of the first closed tubular element 14 and the second outer lateral surface 45 of the second closed tubular element 15 are aligned flush, and the first closed tubular element 14 and the second closed tubular element 15 are connected to each other. The connection takes place here via the first upper end surface 44 of the first closed tubular element 14 and the second lower end surface 47 of the second closed tubular element 15. The connection between the first upper end surface 44 and the second lower end surface 47 takes place, for example, by welding.

Since the first outer lateral surface 41 and the second outer lateral surface 45 are aligned flush and the second width B₂ is less than the first width B₁, the first upper end surface 44 of the first closed tubular element 14 forms an annular stop shoulder 49 on the inner side of the cutting section 11 for the transmission of force from a connected drill shaft section. The cutting section 11 is designed in such a manner that force is transmitted from the drill shaft section 12 to the cutting section 11 via the first closed tubular element 14 and torque is transmitted from the drill shaft section 12 to the cutting section 11 via the second closed tubular element 15.

Torque is transmitted from the drill shaft section 12 to the cutting section 11 via the pin elements 23 and the slot-shaped recesses 24. The second closed tubular element 15 of the cutting section 11 has a plurality of slot-shaped recesses 24 on the second upper end surface 48. The slot-shaped recesses 24 each comprise a transverse slot 51 and a connecting slot 52, wherein the connecting slot 52 connects the transverse slot 51 to the second upper end surface 48.

The first closed tubular element 14 can be produced from a first material and the second closed tubular element 15 from a second material. By separation of the cutting section 11 into the first closed tubular element 14 and the second closed tubular element 15, the choice of the first material and of the second material can be adapted to the different demands made of the first closed tubular element 14 and of the second closed tubular element 15.

What is claimed is:

1-9 (canceled)

10. A cutting section for a drill bit, the cutting section being connectable to a drill shaft section of the drill bit via a releasable connection, the cutting section comprising:
a first closed tubular element in the form of a first hollow cylinder having a first waved, trapezoidal or zigzag-shaped cross-sectional area and having a first hollow cylinder height, a first inside diameter and a first outside diameter;
a second closed tubular element in the form of a second hollow cylinder having a second circular ring-shaped cross-sectional area and having a second hollow cylinder height, a second inside diameter and a second outside diameter, wherein the first inside diameter is smaller than the second inside diameter, and the first outside diameter is larger than or equal to the second outside diameter; and
at least one drill segment connected to the first closed tubular element;
a first upper end surface of the first closed tubular element being connected to a second lower end surface of the second closed tubular element.

11. The cutting section as recited in claim 10 wherein the first outside diameter is equal to the second outside diameter, and the first outer lateral surface and the second outer lateral surface are aligned flush.

12. The cutting section as recited in claim 10 wherein the second closed tubular element has at least one slot-shaped recess, the at least one slot-shaped recess having a transverse slot and a connecting slot, and the connecting slot connecting the transverse slot to the second upper end surface of the second closed tubular element.

13. The cutting section as recited in claim 12 wherein the second closed tubular element in the second inner lateral surface has at least one transverse groove arranged level with the connecting slot of the at least one slot-shaped recess.

14. The cutting section as recited in claim 10 wherein the first closed tubular element is formed from a first material and the second closed tubular element from a second material.

15. The cutting section as recited in claim 10 wherein the first closed tubular element is in the form of a first formed sheet metal part.

16. The cutting section as recited in claim 10 wherein the second closed tubular element is in the form of a second formed sheet metal part.

17. The cutting section as recited in claim 16 wherein the second formed sheet metal part has at least one second positive form fitting element and at least one corresponding second negative form fitting element on opposite sides, wherein the at least one second positive form fitting element and the at least one second negative form fitting element are connected in a form fitting manner in the second closed tubular element.

18. A core bit comprising:
the cutting section as recited in claim 10; and
the drill shaft section, the cutting section and the drill shaft section connectable via the releasable connection.
